(19) United States
(12) Patent Application Publication
(10) Pub. No.: US 2007/0146814 A1
(43) Pub. Date: Jun. 28, 2007

(54) Read Control System, Method and Computer Readable Medium

(75) Inventor: Hiroyuki Asada, Kanagawa (JP)

Correspondence Address: GAUTHIER & CONNORS, LLP, 225 FRANKLIN STREET, SUITE 2300, BOSTON, MA, 02110, US

(73) Assignee: Fuji Xerox Co., Ltd., Tokyo (JP)

(21) Appl. No.: 11/559,437

(22) Filed: Nov. 14, 2006

(30) Foreign Application Priority Data
Dec. 26, 2005 (JP) 2005-371762

(51) Int. Cl. H04N 1/04

(52) U.S. Cl. 358/474

(57) ABSTRACT

There is provided a read control system for controlling an image-reading device that optically reads an image of a document, the system including a read control unit that causes the image-reading device to read a predetermined reading range larger than a document size to acquire image data resulting from reading, a detection unit that detects from the image data an existence range where an image of the document exists, and a file production unit that produces an image file including an image of a whole range of the image data and having information indicating the existence range set as a display area attribute.

### PRIORITY INFORMATION

This application claims priority to Japanese Patent Application No. 2005-371762, filed on Dec. 26, 2005.

### BACKGROUND

1. Technical Field

The present invention relates to systems for reading an image on a document to produce an image file.

2. Related Art

With enactment of the so-called Sarbanes-Oxley Act, documents which have had to be stored in the form of paper media can now be stored as electronic data. As a result, documents which have been stored as paper media are more and more often collectively read with a scanner having an ADF (automatic document feeder), converted into electronic data, and stored as such. Therefore, an increase in problems that the documents cannot be converted into correct electronic data due to inaccurate document feeding and human error is expected.

For example, when some of the stacked paper media to be converted into electronic data are reversed and read in a single-sided (simplex) scan mode, blank sheet data are produced and stored. Depending on the document feeding accuracy of the ADF, the reading operation may be performed while a document is misaligned, due to overfeeding or underfeeding, whereby part of the document cannot be read, or the document may be read with its size judged incorrectly.

### SUMMARY

According to an aspect of the present invention, there is provided a read control system for controlling an image-reading device that optically reads an image of a document, the system including a read control unit that causes the image-reading device to read a predetermined reading range larger than a document size to acquire image data resulting from reading, a detection unit that detects from the image data an existence range where an image of the document exists, and a file production unit that produces an image file including an image of a whole range of the image data and having information indicating the existence range set as a display area attribute.

### BRIEF DESCRIPTION OF THE DRAWINGS

Exemplary embodiments of the present invention will be described in detail by reference to the following figures, wherein:

FIG. 1 is a view for describing problems of a related-art device;

FIG. 2 is a view for describing a concept of a method according to an exemplary embodiment;

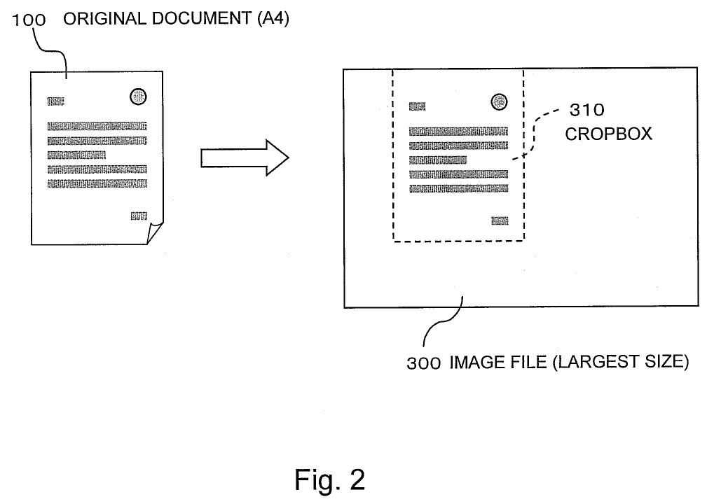

FIG. 3 is a functional block diagram showing a system configuration according to the exemplary embodiment; and

FIG. 4 is a functional block diagram showing a system configuration according to another exemplary embodiment.

### DETAILED DESCRIPTION

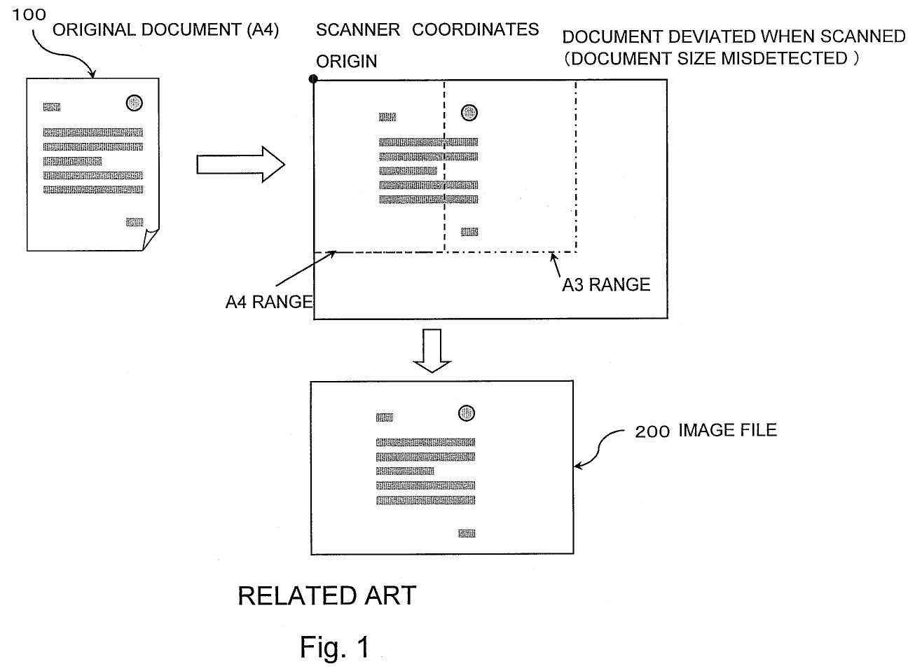

Problems of a device in the related art will first be described with reference to FIG. 1. It is assumed here that, upon feeding of a document 100 of A4 (portrait) size with an ADF and reading it with an image-reading device (e.g. scanner), the document is deviated during the feed, and that an image portion of the document runs off the edge of the A4 (portrait) range. If the image-reading device automatically detects the sheet size (based on the image), the document size is judged as, for example, A3 (landscape) larger than A4 (portrait). The image-reading device, therefore, reads the image in A3 (landscape) size, and produces an image file 200 in a predetermined file format representing the image. In this case, the image file 200 is sized larger than the document 100 and has a large margin, and the image portion of the document is positioned off-center therein. It is, therefore, inappropriate as an archival file.

The size of the sheet is automatically detected in the above case. If the user explicitly specifies the sheet size of the document 100 as A4 (portrait) and the document is deviated upon feeding as illustrated in FIG. 1, the image-reading device produces the A4 (portrait) image file with the portion on the right side of the document missing. This file is also inappropriate as the file used for storing the image of the document 100.

In contrast, according to an exemplary embodiment of the present invention, the image-reading device is caused to read the maximum readable range. For example, if the readable range size (such as the size of a platen glass) of the image-reading device is A3 (landscape), the device is caused to read the A3 (landscape) range regardless of the sheet size of the document, and produces an image file 300 including an image of A3 (landscape) size.

For the file format of the produced image file 300, there is used a format that allows setting of a default display area, a segment of the entire image area included in the image file 300, presented when the image of the file is to be displayed on a screen. When, for example, a PDF (portable document format) file is used, a CropBox can be set as such a display area. If a CropBox 310 is set (as, for example, attribute data) for the image file 300, the program processing the image file 300 cuts out and displays only the image portion of the area indicated by the CropBox 310 when the image file 300 is to be displayed. Programs handling PDF files include Adobe Acrobat (registered trademark) or Adobe Reader used as a viewer, Adobe Acrobat having an editing function (both products are available from Adobe Systems Incorporated), and the like, and these programs display the range of the CropBox 310 on the screen.

According to the present exemplary embodiment, a unit for producing the image file 300 from the image resulting from reading the maximum range that can be read by the image-reading device sets as the CropBox 310 the area of the image file 300 that includes the image portion of the document 100 and is equal in shape and size to the document 100.

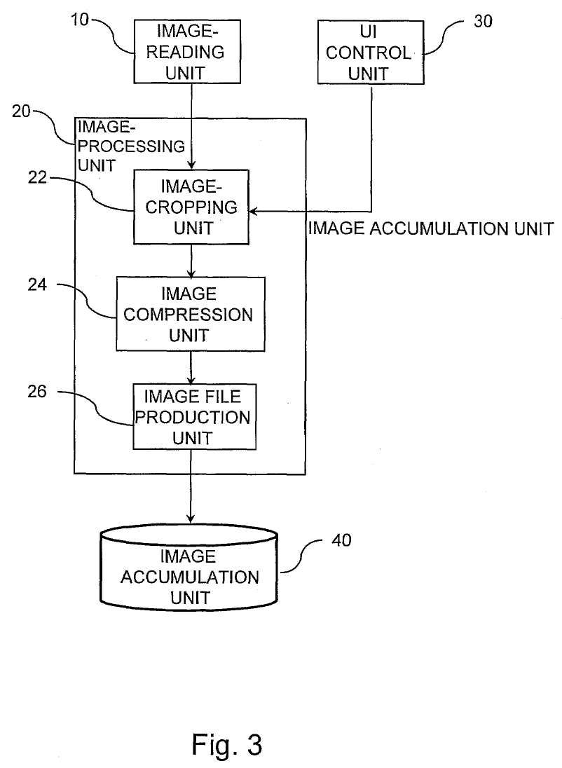

A system configuration for achieving production of such a file is shown in FIG. 3.

The system includes an image-reading unit 10, an image-processing unit 20, a UI control unit 30, and an image accumulation unit 40. The image-reading unit 10 may be a scanner device for optically reading a document. According to the present exemplary embodiment, the image-reading unit 10 has a mode (to be referred to as an archival image file production mode) in which a document is read in the maximum readable size regardless of the document size.

The image-processing unit 20 is a unit for processing a raw image read by the image-reading unit 10 (such as an image signal sequentially output in response to the reading operation or a bit map image), and producing an image file to be accumulated in the image accumulation unit 40. Below is described an example of producing an image file in the PDF format.

The image-processing unit 20 includes an image-cropping unit 22, an image compression unit 24, and an image file production unit 26.

Of the image read by the image-reading unit 10 in the archival image file production mode, an area that includes the image of the document and is equal in size thereto is obtained as a CropBox by the image-cropping unit 22. In this example, the image-cropping unit 22 receives information on the sheet size of the document input by a user to the UI (user interface) control unit 30, and obtains the area of the sheet size as the CropBox. For the cropping operation, an image density (which may be an average pixel value for every n pixels (n is a positive number) in a line or an average pixel value for a block consisting of multiple pixels X multiple pixels) is first obtained for each section of the received maximum size image, and the section having an image density no smaller than a preset threshold is detected as the area where the image exists. The area including such an image existence area and conforming in size and shape to the sheet of the document is used as the CropBox. Because the obtained image existence area is generally smaller than the sheet size, the position of the CropBox may be set so that the existence area is located at the center of the CropBox area. The CropBox is a rectangular area, and may be expressed as a combination of y coordinates of the upper and lower ends and x coordinates of the right and left ends (coordinates are determined on the basis of the origin of the read maximum size image). The information on the CropBox thus obtained by the image-cropping unit 22 is transmitted to the image file production unit 26.

The image compression unit 24 compresses raw image data of the maximum size output from the image-reading unit 10 with a predetermined compression algorithm used in conjunction with the PDF format.

The image file production unit 26 performs processing on the compressed image data output from the image compression unit 24, such as adding necessary attribute information thereto, and produces an image file 300 in the PDF format. In this step, the image file production unit 26 sets information on CropBox coordinates obtained by the image-cropping unit 22 for the CropBox attribute of the image file 300. For a document whose storage is legally required, authentication of originality is required for the file resulting from computerizing such a document. Therefore, in such a case, the image file production unit 26 may acquire the legally required information authenticating originality, such as an electronic signature and a time stamp, and add it to the image file 300.

The image file 300 thus produced by the image file production unit 26 is accumulated in the image accumulation unit 40 (such as a document database for accumulating archival documents).

The system illustrated in FIG. 3 may be implemented as a stand-alone digital multifunction device or scanner device (hereinafter collectively referred to as a device). In such an implementation, the image-reading unit 10 corresponds to an optical reading mechanism of such a device, the UI control unit 30 corresponds to a control panel or a controlling mechanism of a multifunction device or the like, and the image-processing unit 20 corresponds to hardware (such as an integrated circuit for compression and a digital signal processor) and software of a control unit of a multifunction device or the like. The image accumulation unit 40 corresponds to a storage device, such as a hard disk, provided in such a device. When a multifunction device is connected to a network, such as a LAN (local area network) a document database on the network can be used as the image accumulation unit 40.

When the system of this exemplary embodiment is implemented as a multifunction device, the multifunction device includes the archival image file production mode as one of operation modes. When this mode is selected, a control unit (not shown) of the multifunction device causes the image-reading unit 10 to read in the maximum size, and the image-processing unit 20 to produce the image file 300 as described above from the image resulting from the reading step.

The system of this exemplary embodiment may be implemented as a combination of a scanner device and a personal computer or a workstation (hereinafter collectively referred to as a PC or the like) controlling the scanner device. In such a configuration, the image-reading unit 10 corresponds to a scanner device, the image-processing unit 20 corresponds to image-processing software installed in a PC or the like, and the UI control unit 30 corresponds to a UI of the image-processing software. The image accumulation unit 40 corresponds to a folder or database controlled by the PC or the like, or the database on the network connected to the PC or like. With such a system configuration, when a user selects the archival image file production mode of the image-processing software of the PC or the like and sets a document in an ADF of the scanner device, the software causes the scanner device to read the document in the maximum size, and the image file of the document output from the scanner device as a result of reading is received. The software analyzes the image file to obtain a CropBox, converts the image represented by the image file to a PDF format when necessary, and sets an attribute value of the CropBox in the file.

According to the system described above, even if the document is fed in a deviated manner due to malfunction of the ADF or the like, an image file allowing an image portion of the document to be displayed in the same shape and size as that of the document may be produced.

It should be noted that the position of the CropBox may be recognized incorrectly due to effects of noise and the like, because the position of the CropBox is obtained by the image-cropping unit 22 analyzing the image data of the maximum size in the above-described system. When the image file 300 produced by the system is opened in a viewer or the like while the CropBox is misrecognized as such, an image different from that of the document is displayed. However, in such a case as well, the image file 300 includes an image for the area of the maximum size readable by the image-reading unit 10, and therefore the image file 300 includes the document image (unless the document is set to read the reverse side thereof). As a result, it is possible to adjust the CropBox of the image file 300 to the correct position so as to include the document image by using appropriate software (such as Adobe Acrobat or Adobe Illustrator (registered trademark) available from Adobe Systems Incorporated).

Considering the case that the document is set in the ADF in the reversed manner, the image-reading unit 10 may be controlled to always perform a double-sided (duplex) scan in the archival image file production mode, so that the image-processing unit 20 finds the image portion of the document from the resulting images on both sides thereof to set the CropBox. While the image file 300 includes images on both sides; i.e. images for 2 page areas, in this case, the data size can be reduced considerably through compression because most of the area is blank, and therefore the data size of the file 300 is not conspicuously increased. By thus constantly reading the document on both sides, the image file 300 including the image portion of the document can be produced even if some sheets in the document stack are set in a reversed manner. Note that it is assumed in this example that the image-reading unit 10 is equipped with the ADF having a document-reversing mechanism for double-sided scanning.

Although in the above example the maximum area that can be read by the image-reading unit 10 is read, if the sheet size of the document is known, the image-reading unit 10 may be controlled to read the area including the sheet size and the maximum margin for deviation of the document during the feed (the margin can be acquired through experiments or the like by the manufacturer of the image-reading unit 10).

Although the problems of feeding documents by an ADF have been mainly discussed above, the document may also be deviated when a user manually sets the document on a platen glass. The technique of this exemplary embodiment is also applicable to such a case.

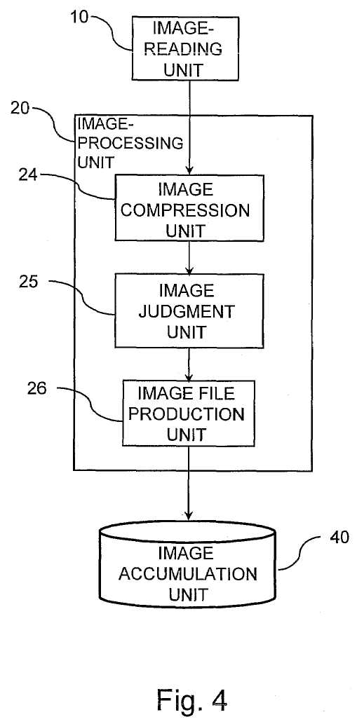

A system according to another exemplary embodiment will next be described with reference to FIG. 4. This system may be used for producing an image file representing an image portion of a document even if the document is set in the ADF in the reversed manner.

In this example, a control unit (not shown) of the system instructs the image-reading unit 10 to always read the document in a double-sided manner in the archival image file production mode. The resulting image data for both sides is input to the image compression unit 24 of the image-processing unit 20, and subjected to compression conforming to the PDF format. Of the compressed image data for both sides, an image judgment unit 25 determines data for the blank side from the output from the image compression unit 24. Because the blank side is generally rendered into data of a very small size through compression, the image judgment unit 25 may compare the data size of each side output from the image compression unit 24 with a preset threshold (the threshold may be varied with the sheet size of the document), and determine the side having the data size smaller than the threshold as the blank side. Alternatively, some image compression units 24 determine the blank page and output a value indicating the blank page, and therefore judgment may be made by reference to this value. If the image compression unit 24 is of the type that outputs an image density of the image for each side (average for one side), a side having the image density lower than the threshold can be determined as blank.

The image file production unit 26 arranges, among compressed image data for two sides output from the image compression unit 24, the compressed image data for the side judged as not being blank by the image judgment unit 25 to the PDF format, and adds an attribute, such as information for authenticating originality, when necessary, thereby producing an image file to be accumulated in the image accumulation unit 40.

Although the PDF format has been described above as an example of the format of the image file 300, each system of the exemplary embodiments described above can be used with any file format, so long as a section of the image represented by the image file can be set as a display area to be displayed by default.

The above-described system is typically implemented by executing, on a general-purpose computer, a program describing the functions or processing of the above-described components. For hardware the computer has circuitry in which components such as a CPU (Central Processing Unit), memory (primary storage), and various I/O (input/output) interfaces are connected with each other via a bus. For example, a hard disk drive and a disk drive for reading removable nonvolatile recording media of various standards, such as CDs, DVDs, and flash memory, are connected to the bus, via the I/O interfaces. These drives and function as external storage devices for the memory. The program describing the processing of the system of the exemplary embodiment is stored in a secondary storage device such as the hard disk drive via a recording medium such as a CD or DVD, or over a network, and installed on the computer. The program stored in the secondary storage device is read out to the memory and executed by the CPU, thereby implementing the processing of the exemplary embodiment.

The foregoing description of the exemplary embodiments of the present invention has been provided for the purposes of illustration and description. It is not intended to be exhaustive or to limit the invention to the precise forms disclosed. Obviously, many modifications and variations will be apparent to practitioners skilled in the art. The embodiments were chosen and described in order to best explain the principles of the invention and its practical applications, thereby enabling others skilled in the art to understand the invention for various embodiments and with various modifications as are suited to the particular use contemplated. It is intended that the scope of the invention be defined by the following claims and their equivalents.

What is claimed is:

1. A read control system, comprising:
a read control unit that causes an image-reading device to read a predetermined reading range larger than a document size to acquire image data resulting from reading;
a detection unit that detects from the image data an existence range where an image of a document exists; and
a file production unit that produces an image file including an image of a whole range of the image data and having information indicating the existence range set as a display area attribute.

2. The read control system according to claim 1, wherein
the read control unit causes the image-reading device to read the maximum readable range of the device.

3. The read control system according to claim 1, wherein
the read control unit causes the image-reading device to read in a double-sided scan mode to acquire image data for both sides, and
the file production unit produces the image file including the whole range of the image data for both sides and having the existence range set as a display area.

4. The read control system according to claim 1, wherein
the detection unit detects as the existence range an area including a portion of the image data having an image density greater than a predetermined threshold and corresponding to the document size.

5. A read control system, comprising:
a read control unit that causes an image-reading device to read a document in a double-sided scan mode to acquire image data resulting from reading for both sides; and
a file production unit that detects a blank side from the image data for both sides, and produces an image file in a predetermined file format from the image data for the side other than the blank side.

6. A read control method, comprising:
causing an image-reading device to read a predetermined reading range larger than a document size to acquire image data resulting from reading;
detecting from the image data an existence range where an image of a document exists; and
producing an image file including an image of a whole range of the image data and having information indicating the existence range set as a display area attribute.

7. The read control method according to claim 6, wherein
causing the image-reading device to read the reading range includes causing the image-reading device to read for the maximum area that can be read with the device.

8. The read control system according to claim 6, wherein
causing the image-reading device to read the reading range includes causing the image-reading device to read in a double-sided scan mode to acquire image data for both sides, and
producing the image file includes producing an image file including the whole range of the image data for both sides and having the existence range set as a display area.

9. The read control system according to claim 6, wherein
detecting the existence area includes detecting as the existence range an area including a portion of the image data having an image density equal to or greater than a predetermined threshold and corresponding to the document size.

10. A read control method, comprising:
causing an image-reading device to read a document in a double-sided scan mode to acquire image data for both sides; and
detecting a blank side from the image data for both sides, and producing an image file in a predetermined file format from the image data for the side other than the blank side.

11. A computer readable medium storing a program for causing a computer to execute a process for read control, the process comprising:
causing an image-reading device to read a predetermined reading range larger than a document size to acquire image data resulting from reading;
detecting from the image data an existence range where an image of a document exists; and
producing an image file including an image of a whole range of the image data and having information indicating the existence range set as a display area attribute.

12. The medium according to claim 11, wherein
causing the image-reading device to read the reading range includes causing the image-reading device to read for the maximum area that can be read with the device.

13. The medium according to claim 11, wherein
causing the image-reading device to read the reading range includes causing the image-reading device to read in a double-sided scan mode to acquire image data for both sides, and
producing the image file includes producing an image file including the whole range of the image data for both sides and having the existence range set as a display area.

14. The read control system according to claim 11, wherein
detecting the existence area includes detecting as the existence range an area including a portion of the image data having an image density equal to or greater than a predetermined threshold and corresponding to the document size.

15. A computer readable medium storing a program for causing a computer to execute a process for read control, the process comprising:
causing an image-reading device to read a document in a double-sided scan mode to acquire image data for both sides; and
detecting a blank side from the image data for both sides, and producing an image file in a predetermined file format from the image data for the side other than the blank side.
